(19) United States
(12) Patent Application Publication
(10) Pub. No.: US 2009/0050080 A1
(43) Pub. Date: Feb. 26, 2009

(54) HYDROGEN PEROXIDE-FUELED ROTARY EXPANSION ENGINE

(75) Inventors: James M. Hair, III, Cheyenne, WY (US); Daniel L. Greene, Cheyenne, WY (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: ABET TECHNOLOGIES, LLC, Evanston, IL (US)

(21) Appl. No.: 12/196,869

(22) Filed: Aug. 22, 2008

Related U.S. Application Data
(60) Provisional application No. 60/957,810, filed on Aug. 24, 2007.

(51) Int. Cl. F02B 43/12; F02B 53/10

(52) U.S. Cl. 123/3; 123/220; 123/205

(57) ABSTRACT

A hydrogen peroxide-fueled engine system is provided. Embodiments of the system include: a source outputting liquid hydrogen peroxide; a decomposition chamber including an inlet in fluid communication with the source for receiving the liquid hydrogen peroxide, an outlet, and a catalyst interposed between the inlet and the outlet; and a rotary expansion engine including a gas outlet, a gas inlet in fluid communication with the outlet of the decomposition chamber, a generally lobe-shaped expansion chamber in fluid communication with the gas inlet and the gas outlet, and a rotor contacting a surface of the lobe-shaped expansion chamber between the gas outlet and the gas inlet, the rotor including an output shaft and diametrically-opposed first and second sealing arms that pivot outwardly to contact the surface. In another aspect, a method of producing rotational energy from decomposition of liquid hydrogen peroxide is provided.

### CROSS-REFERENCE TO RELATED PATENT APPLICATIONS

This patent application claims the benefit of U.S. Provisional Patent Application No. 60/957,810, filed Aug. 24, 2007.

### FIELD OF THE INVENTION

This invention pertains generally to rotary machines. More particularly, the present invention pertains to rotary expansion engines.

### BACKGROUND OF THE INVENTION

One common and familiar chemical is Hydrogen Peroxide (hereinafter H₂O₂ or peroxide). H₂O₂ is an extremely useful chemical, the capabilities of which are being expanded daily beyond its use as a sanitizer, oxidizer, and bleaching agent.

Physically, H₂O₂ is a very pale blue liquid which appears colorless in a dilute solution. H₂O₂ is slightly more viscous than water and is a very weak acid. Traditionally, many of the functional applications of H₂O₂ have been accomplished by a variety of other more unstable or unsafe chemicals. But, as environmental concern regarding such chemicals' usage and safety regulations regarding their manufacture, storage, transportation and use have mounted and the consequences of residual chemical contamination left by more complex chemicals has begun to be taken more seriously, active searches for a viable alternatives to more complex and toxic chemicals are beginning in earnest and accelerating.

One consideration when evaluating H₂O₂ as a potential source of energy for generating heat, pressure or mechanical energy is to dissociate it from the common perception that fuel must be combusted (as gasoline is) in order for it to be effective. H₂O₂ possess a great deal of potential energy which is released by decomposing or disassociating it, for example in the presence of an appropriate catalyst. This process of decomposition breaks down the H₂O₂ into its constituent components, water and oxygen. As known in the art, this reaction is represented as:

2H₂O₂=O₂+2H₂O.

That is, peroxide=oxygen and water+heat (e.g., steam, or a mixture of water and steam)

Since the reaction is highly exothermic, H₂O₂ may produce considerable amounts of heated, high pressure steam and oxygen (hereinafter collectively referred to as gas). Furthermore, the amount of expansion of H₂O₂ is considerable. Given a 70% concentration, a single unit of liquid H₂O₂ can expand to 2700 units of resultant vapor under high pressure, if contained within an appropriate pressure chamber.

This reaction is not instantaneous, and requires a short time to accomplish. This characteristic, among others such as the foregoing-described volume-expanding and exothermic properties, has made the use of H₂O₂ as a sole fuel within internal combustion engines difficult to impractical. The speed of this reaction is determined by many factors including, but not limited to: the amount and type of catalyst utilized, the configuration and/or physical attributes of the catalyst, the pressure under which the reaction is accomplished, and the temperature of the catalyst.

Although various conventional internal combustion (IC) engines such as reciprocating cylinder- and rotary-type (e.g., Wankel) engines are known in the art for combusting fuel (e.g., gasoline) such engines have proven impractical and inefficient when adapted for catalytic-type reactions. Furthermore, while some conventional IC engines combust fuel in combination with H₂O₂, none of these engines rely on H₂O₂ as a monofuel (i.e., sole fuel source). Moreover, although H₂O₂ is a well-known monopropellant/monofuel for rockets and other projectiles, H₂O₂ has not been associated with conventional steam and rotary expansion engines as a proper fuel due to difficulties in controlling H₂O₂ decomposition for obtaining the maximum energy therefrom. In view of the foregoing a H₂O₂ fueled rotary expansion engine would be an important improvement in the art.

### BRIEF SUMMARY OF THE INVENTION

A hydrogen peroxide-fueled engine system is provided. Embodiments of the system include: a source outputting liquid hydrogen peroxide; a decomposition chamber including an inlet in fluid communication with the source for receiving the liquid hydrogen peroxide, an outlet, and a catalyst interposed between the inlet and the outlet; and a rotary expansion engine including a gas outlet, a gas inlet in fluid communication with the outlet of the decomposition chamber, a generally lobe-shaped expansion chamber in fluid communication with the gas inlet and the gas outlet, and a rotor contacting a surface of the lobe-shaped expansion chamber between the gas outlet and the gas inlet, the rotor including an output shaft and diametrically-opposed first and second sealing arms that pivot outwardly to contact the surface. In another aspect, a method of producing rotational energy from decomposition of liquid hydrogen peroxide is provided.

Rotary expansion engines employed in the present system have no internal gears, reciprocating pistons, crankshaft or carburetion. The present engines utilize high pressure gas resulting from decomposition of liquid hydrogen peroxide to drive a main rotor in a lobe-shaped expansion chamber via connected and movable sealing arms. High pressure gas introduced into the expansion chamber expands against the sealing arms, thereby causing the rotor to rotate. As the gas expands it moves the sealing arms between high and low pressure areas in the expansion chamber. The differential in pressure thereby produces rotational torque energy.

### BRIEF DESCRIPTION OF THE DRAWINGS

FIG. 1 diagrammatically illustrates an embodiment of a hydrogen peroxide-fueled engine system with an example rotary expansion engine;

FIGS. 2-3 illustrate operation of the example rotary expansion engine of FIG. 1;

FIG. 4 diagrammatically illustrates an example hydrogen peroxide-decomposition subsystem for the system of FIG. 1;

FIG. 5 illustrates an end view of an example rotary expansion engine for the system of FIG. 1;

FIGS. 6-7 diagrammatically illustrate operation of an example gas injection mechanism for the system of FIG. 1;

FIG. 8 diagrammatically illustrates an example pressure regulator for the system of FIG. 1;

FIG. 9 diagrammatically illustrates a second example rotary expansion engine for the system of FIG. 1;

FIG. 10 is a detail view of a portion of FIG. 9 showing features of the second example rotary expansion engine;

FIG. 11 diagrammatically illustrates a third example rotary expansion engine for the system of FIG. 1;

FIGS. 12A-12D illustrate an example pivoting pressure seal arm of the third example rotary expansion engine shown in FIG. 11; and

FIG. 13 illustrates an example end plate for a rotary expansion engine.

### DETAILED DESCRIPTION

Turning now to the Figures, a rotary expansion engine is provided. Although the energy and motive force for operating embodiments the present engine is described as being provided by the decomposition of H₂O₂ (i.e., reaction of H₂O₂ with a catalyst), other embodiments of the present engine may operate using various fuels known in the art which may combust or react to produce pressure and/or heat. Furthermore, various compressed gasses (e.g., O₂, CO₂, etc.) and steam may be used to operate the present engine. The H₂O₂ used in various embodiments may be High Test Peroxide (HTP)—H₂O₂ of a high concentration (e.g., 70%, or 85-98%). As known in the art, decomposition of a 70% HTP solution provides an exothermic product of approximately 480 cal/gm heat energy, which would translate to a resultant temperature of >600 degrees Celsius. However, it should be appreciated that the concentration of the H₂O₂ is not limiting on the present invention. Furthermore, it may be highly preferred in certain embodiments to use H₂O₂ with a threshold concentration of >64% so that the H₂O₂ is substantially decomposed with little or no residual H₂O₂ remaining, and so that water which results from decomposition is substantially produced in vapor (i.e., steam) form.

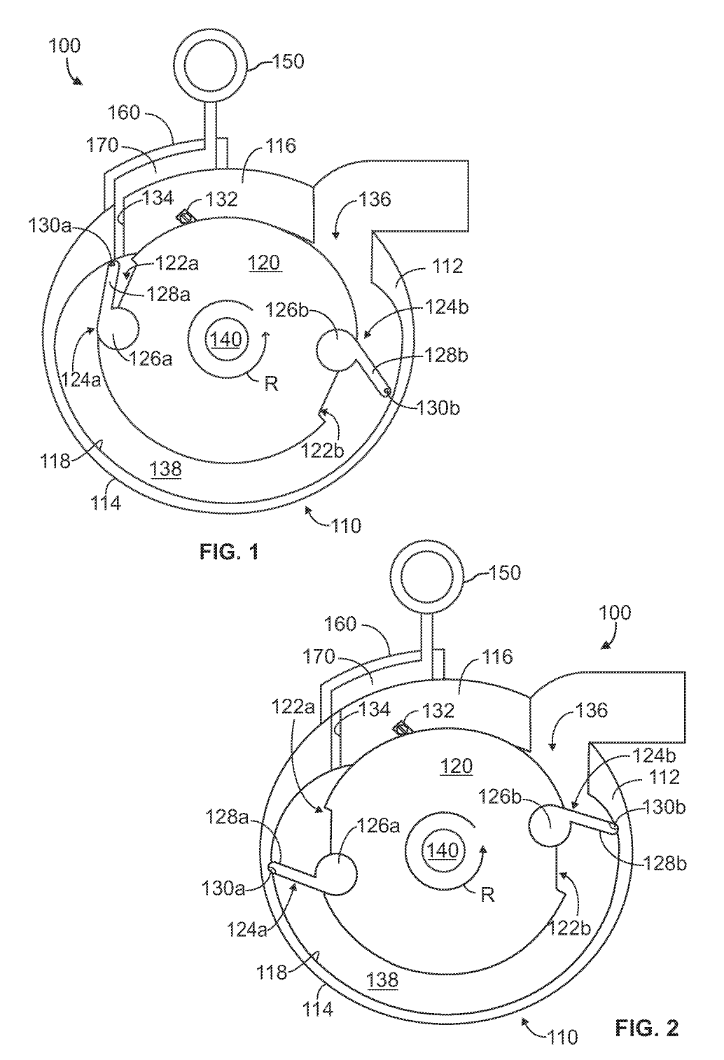

As shown in FIG. 1, an example engine system 100 includes a rotary expansion engine 110, a H₂O₂ source 150, and a H₂O₂ decomposition subsystem 160 interposed between the source 150 and the engine 110. The H₂O₂ source 150 may be a reservoir or vessel as shown holding liquid H₂O₂. Alternatively, the H₂O₂ source 150 may be an apparatus, system, generator or the like for producing/generating H₂O₂ (e.g., by way of an electrochemical reaction). As shown, the H₂O₂ source 150 includes an outlet that is in fluid communication with the H₂O₂ decomposition subsystem 160. The H₂O₂ flowing from the source 150 enters the decomposition subsystem 160 and reacts with a catalyst 170 configured in the subsystem 160. The catalyst 170 may be various materials known in the art such as ceramics, metals (e.g., manganese and precious metals including silver, platinum) including alloys, salts, and oxides thereof, and the like. The catalyst 170 may be configured as a catalyst bed or screen with a high surface area. The decomposition system 160, which will be described in further detail hereinafter, as shown includes an outlet for feeding gas resulting from H₂O₂ decomposition to the rotary expansion engine 110.

Although the system 100 is shown as including one single engine 110, the present system may include additional engines. In one example a system includes two engines that are paired together, offset by one hundred eighty degrees. This concept allows for the incremental increase of engines (e.g., from two to four to six etc.) for increasing the available power of the system as necessary to meet designed demand while maintaining smooth operation. The rotary expansion engine 110 includes a stator or housing 112 and a rotor 120 within the housing 112 that is configured to rotate (as indicated by circular arrow marked “R” in FIGS. 1-3) relative to the housing 112. As shown, the housing 112 has a generally cylindrical configuration with a generally circular outer perimeter. An output shaft 140 of the rotor 120 is generally coaxial with a central axis extending through the housing 112 and, therefore the shaft 140 is centered with respect to the generally circular outer perimeter of the engine 110. The housing 112 includes two portions, a thin wall portion 114 and a thick wall portion 116. The thin wall and thick wall portions 114, 116 may be unitary or integral such that the housing 112 is one-piece. Due to the configuration of the thin wall and thick wall portions 114, 116, the inside wall or surface 118 of the housing 112 is generally lobed in shape. However, the housing 112 may be configured in other ways such that the inside wall or surface 118 is curvilinear or eccentric in shape relative to the configuration of the rotor 120. The rotor 120, which has a generally circular, cylindrical outer surface, is configured within the housing 112 with a portion of the outer surface of the rotor 120 being in contact with the inside wall or surface 118, particularly the inside surface of thick wall portion 116. As can be appreciated, the outer surface of the rotor 120 contacting with the inside wall or surface 118 provides a first seal to separate the expansion chamber 138 (i.e., the volume between the inside surface 118 of the housing 112 and the outer surface of the rotor 120) into two or more areas. As shown, a seal 132 may be configured in the housing 112 to further seal the high pressure gas inlet 134 from the low pressure outlet 136. The seal 132 may be of the stationary or moving (e.g., a rolling ball and/or cylindrical rod) type.

As further shown in FIG. 1, the rotor 120 includes a central output shaft 140 for transferring rotational movement and energy to an external apparatus that is coupled with the shaft 140. The rotor 120 also includes two cavities or recesses 122a, 122b in the surface of the rotor 120 and two pivoting pressure seal arms 124a, 124b (hereinafter referred to as arms or PPSA). Although two cavities or recesses 122a, 122b and two corresponding arms 124a, 124b are shown, it should be appreciated that the rotor 120 may be configured with additional recesses or arms. As shown, the arms 124a, 124b are substantially similar to each other and are configured in a diametrically opposed orientation (i.e., oriented about one hundred eighty degrees from each other) such that when the rotor 120 is bisected by a plane extending through a center of the shaft 140 a first half of the rotor 120 including the first arm 124a is a mirror image of a second half of the rotor 120 including the second arm 124b. Since the arms 124a, 124b are substantially similar, only arm 124a will be described hereinafter for brevity.

As shown, arm 124a includes a first portion 126a and a second portion 128a. First portion 126a is pivotally or hingably coupled with the rotor 120 and second portion 128a extends outward from the first portion to terminate in a distal end 130a. Distal end 130a is configured to contact the inner surface 118 of the housing 112 thereby dividing the expansion chamber 138 into two portions—a first portion that is between the distal end 130a and the gas inlet 134, and a second portion that is between the distal end 130a and the distal end 130a of the diametrically opposed arm 124b. As can be appreciated from viewing arm 124b in FIGS. 1-3 sequentially, as the rotor 120 rotates in the housing 112, the arms 124a, 124b are configured to extend from and retract into the respective recesses 122a, 122b. As each arm 124a, 124b passes the gas outlet 136, the curvature of the inner surface 118 of the housing 112 is configured in such a way as to guide and force the arms 124a, 124b to retract into its corresponding cavity 124a, 124b. Accordingly, it can be appreciated that the shape of the inner surface 118 and thicknesses of the wall portions 114, 116 facilitate movement of the arms 124a, 124b. Although not shown in FIGS. 1-3, the arms 124a, 124b may each include a normal bias that urges the arms 124a, 124b outward such that distal ends 130a, 130b maintain contact with the inner surface 118. As an analogy, the distal ends 130a, 130b act as cam followers which track the inner surface 118 being the cam surface. The bias may be various biasing apparatuses known in the art such as springs (e.g., torsion spring), magnets, etc.

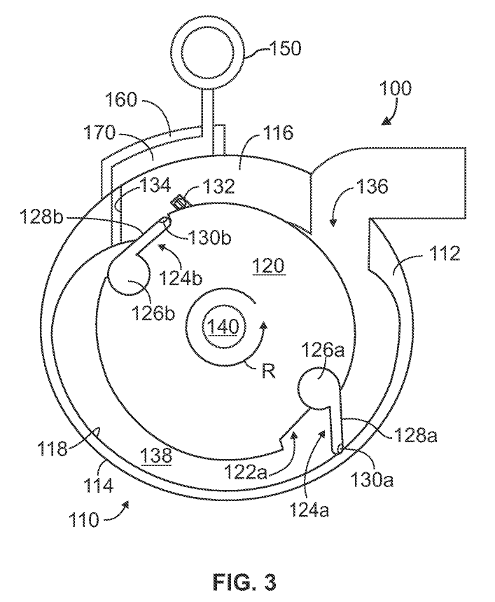

Referring now to FIGS. 1-3, which when viewed in succession illustrate an approximate half-revolution of the rotor 120, operation of the rotary expansion engine 110 is explained. As shown in FIG. 1, the rotor 120 is oriented in an initial rotational position with the first arm 124a being slightly extended from recess 122a such that distal end 130a is contacting the inner surface 118 just past the gas inlet 134. Although operation of the engine 110 is described as starting from an initial position shown in FIG. 1, the initial rotational position of the rotor 120 (and positions of arms 124a, 124b) is not limiting on the invention. Indeed, an initial position of the rotor 120 may be such that arm 124a is fully retracted (e.g., distal end 130a contacting the seal 132 or an inner surface of the thick walled portion 116) or fully extended. High pressure gas flowing through the gas inlet 134 occupies a portion of the volume of the expansion chamber 138 between arm 124a and the seal 132 (or alternatively a seal created by intimate abutment/contact of the rotor 120 with the thick wall portion 116) and begins to expand and cool. As the gas expands it presses against the arm 124a thereby providing a motive force to move the arm 124a away from the gas inlet 134 and to rotate the rotor 120 as indicated by arrow R. FIG. 2 shows the rotor 120 after rotating slightly due to initial expansion of the high pressure gas. After further expansion of the high pressure gas, the rotor 120 has rotated to a rotational position shown in FIG. 3. As shown in FIG. 2, the second arm 124b is approaching the gas outlet 136 as the first arm 124a is being moved away from the gas inlet 134 by high pressure gas expansion and, therefore, the second arm 124b begins to retract toward the recess 122b due to the shape of the inner surface 118 and/or increasing thickness of the housing 112. As shown in FIG. 3, the second arm 124b has moved past the gas outlet 136 and is fully retracted into recess 122b due to further expansion of the high-pressure gas acting on the first arm 124a. As first arm 124a moves past the gas outlet 136, the rotor 120 has rotated through an angle of about one hundred eighty degrees and the gas that worked on first arm 124a is exhausted from the engine 110.

To begin the process of turning the rotor 120 through another one hundred eighty degrees (completing a revolution of the rotor 120), additional high pressure gas enters the engine to occupy portion of the volume of the expansion chamber 138 between arm 124b and the seal 132 (or alternatively a seal created by intimate abutment/contact of the rotor 120 with the thick wall portion 116) and the foregoing-described gas expansion process is repeated. Although it may be preferred in some embodiments of the engine to discretely inject a fixed amount of high pressure gas into the expansion chamber after an arm has traveled past the gas inlet, in other embodiments the high pressure gas may flow continuously into the expansion chamber regardless of the rotational position of the rotor and orientation of the arms. Furthermore, in some embodiments the system may include a pressure regulator for increasing or decreasing the volume and/or pressure of gas introduced into the expansion chamber.

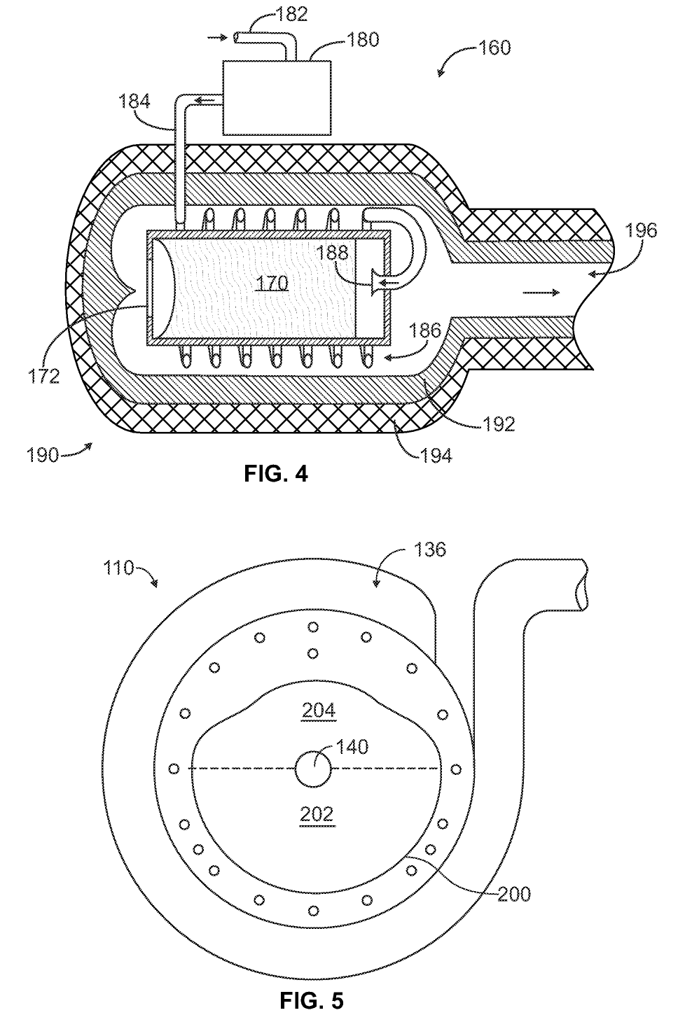

Turning now to FIG. 4, the decomposition subsystem 160 will be described in further detail. As shown in FIG. 4, an example decomposition subsystem 160 includes a liquid pump 180 and a decomposition chamber 190. The liquid pump 180 receives liquid H₂O₂ from the source 150 (FIGS. 1-3) via inlet conduit or pipe 182. The liquid pump 180 pressurizes the received liquid H₂O₂ and outputs pressurized liquid H₂O₂ to an outlet conduit or pipe 184. In some embodiments, the liquid pump 180 may be of the metered type to output a predetermined discrete volume of liquid H₂O₂ to the pipe 184 and/or adjust the liquid pressure in the pipe 184. Alternatively, the liquid pump 180 may be of the continuous type to deliver a constant flow of liquid H₂O₂. Pressure of the liquid H₂O₂ output from liquid pump 180 may be in the range of hundreds to thousands of pounds per square inch (PSI) relative to the configuration/type of catalyst 170 and the operating conditions of the decomposition chamber 190.

As shown, outlet pipe 184 may include a helical portion 186 that extends around a container or object (e.g., catalyst bed, screen, etc.) configured with the catalyst 170. The helical portion 186 acts as a heat exchanger since the reaction of H₂O₂ with the catalyst 170 within the container or object is exothermic and the pressurized H₂O₂ in helical portion 186 becomes heated by heat escaping the container or object. Accordingly, the helical portion 186 helps pre-heat the liquid H₂O₂ to facilitate decomposition. The helical portion 186 terminates in an end that is disposed within the catalyst-configured container or object. The end of helical portion 186 may be configured as or have attached thereto a nozzle 188 for distributing the liquid H₂O₂ to the catalyst 170 as an atomized liquid (i.e., a mist of very small droplets). The combination of pre-heating in the helical portion 186 and atomization by the nozzle 188 may be desirable in some embodiments as this combination may enhance and speed up the catalytic reaction. However, other embodiments of the system may include only one or neither of the helical portion 186 and the nozzle 188, for example depending on the catalyst 170 being employed.

As further shown in FIG. 4, the decomposition chamber 190 further includes a pressure vessel 192 enclosing the container or object (e.g., catalyst bed) configured with the catalyst 170, and insulation 194 enclosing or surrounding the pressure vessel 192. High pressure gas resulting from decomposition of the liquid H₂O₂ escapes the container or object (e.g., catalyst bed) configured with the catalyst 170 via outlet 172 and enters the pressure vessel 192. As can be appreciated, the pressure vessel 192 is configured to safely withstand and contain the high pressure gas resulting from decomposition of the liquid H₂O₂. The high pressure gas moves from outlet 172 through the vessel 192 to gas outlet 196 which may be in direct or indirect fluid communication with the rotary expansion engine for rotating the rotor thereof. Although not required, the insulation 194 is preferred in some embodiments to prevent heat loss from the decomposition chamber 190 and provide a substantially adiabatic environment, thereby maximizing efficiency of the rotary expansion engine. As shown in FIG. 5, the gas outlet 136 of engine 110 may be connected to a circular or helical exhaust pipe that extends around engine 110 to equalize the temperature of the gas expanding in expansion chamber 138 (FIGS. 1-3), thereby preventing or substantially reducing occurrences of hot spots or uneven thermal areas. In this way, heat loss from the expansion chamber 138 is minimized to further provide a substantially adiabatic environment for the system. Furthermore, the exhaust pipe may be configured to “tune” the exhaust. This “tuning” refers to the appropriate length and/or diameter of the exhaust pipe to create a low pressure within the exhaust itself to assist in the extraction of exhaust gasses from the gas outlet 136.

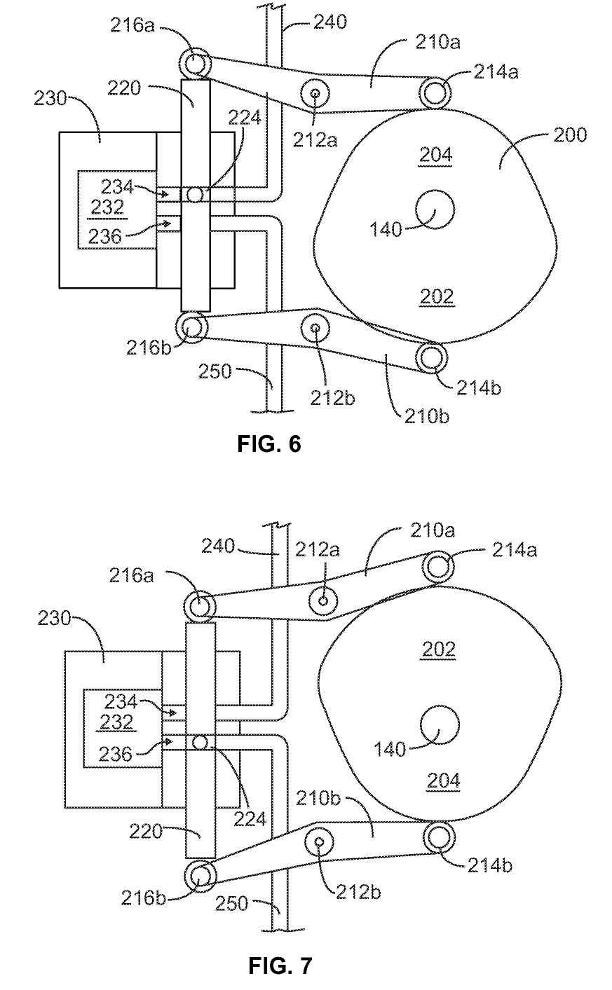

Turning now to FIGS. 5-7, operation of the system 100 (FIG. 1) is further described. As previously mentioned, in some embodiments it may be desirable to discretely inject a fixed amount of high pressure gas into the expansion chamber in a timed manner (e.g., after an arm 124a, 124b has traveled past the gas inlet 134). To this end, the example engine 110 may include a cam that is coupled with the output shaft 140. As shown in FIG. 5, an example cam 200 is configured externally on the engine 110 to rotate with the shaft 140. The cam 200 has a shape that is similar to the lobe-shape of the inner surface 118 of the housing 112. That is, the cam 200 includes a generally semicircular portion 202 and an eccentrically-shaped portion 204 as shown in FIG. 5, however, the cam 200 may be configured otherwise. The cam 200 is coupled to the output shaft 140 to communicate or otherwise convey the rotational position of rotor 120 to a gas injection mechanism (one example thereof being shown in FIGS. 6 and 7) for timing the injection of high pressure gas into the engine. However, other embodiments of the engine may employ other means of determining a relative or absolute rotational position of the rotor 120, for example magnetic or optical rotary encoders and the like.

As shown in FIGS. 6 and 7, one example gas injection mechanism includes a gas reservoir 230 and a valve mechanism that opens and closes the reservoir 230. The gas reservoir 230 includes an interior volume 232, and an inlet 234 and an outlet 236 in fluid communication with the interior volume 232 for respectively filling the volume with high pressure gas and venting the volume 232. In some embodiments the interior volume 232 of the reservoir 230 may be adjustable for increasing or decreasing the pressure of a discrete volume of gas that is introduced into the reservoir 230 via inlet 234. Although not shown, the gas reservoir 230 may be insulated (e.g., with insulation 194 of FIG. 4) to further provide a substantially adiabatic environment for the system. As shown, an inlet conduit or pipe 240 is in fluid communication with the inlet 234, and an outlet conduit or pipe 250 is in fluid communication with the outlet 236. The inlet pipe 240 may be in fluid communication with the outlet 196 (FIG. 4) for receiving the high pressure gas resulting from liquid H₂O₂ decomposition. Furthermore, the outlet pipe 250 may be in fluid communication with the gas inlet 134 of the engine 110 (FIGS. 1-3) or in fluid communication with a pressure regulator, which will be described hereinafter, that is interposed between the gas injection mechanism and the gas inlet 134 of the engine 110. A movable member or armature 220 that includes an aperture 224 is coupled with the gas reservoir 230 so that the aperture may be aligned with either the inlet 234 or the outlet 236. That is, when armature 220 is moved so that the aperture 224 is aligned with the inlet 234, the armature 220 seals the outlet 236 so that the interior volume 232 may be filled. Similarly, when armature 220 is moved so that the aperture 224 is aligned with the outlet 236, the armature 220 seals the inlet 234 so that the interior volume 232 may be vented or exhausted to the outlet pipe 250.

To move the armature 220 in a reciprocating manner, a linkage mechanism is configured between the cam 200 and the armature 220. As shown, the example linkage mechanism includes a first arm 210a and a second arm 210b. However, the linkage mechanism may be configured differently (e.g., with only one arm). First arm 210a includes a central pivot point 212a, a first end 214a including or defining a cam follower that contacts a perimeter of the cam 200, and a second end 216a coupled with a first end of the armature 220. Being a substantially mirror image of first arm 210a, second arm 210b includes a central pivot point 212b, a first end 214b including or defining a cam follower that contacts a perimeter of the cam 200, and a second end 216b coupled with a second end of the armature 220. As can be appreciated from FIGS. 6 and 7 when viewed in succession, the two cam followers on first ends 214a, 214b track the movement of the cam 200 as it rotates, thereby pivoting the arms 210a, 210b and moving the armature 220 back and forth so that the aperture 224 reciprocates between the inlet 234 and outlet 236 of the gas reservoir 230. Accordingly, the gas injection mechanism may open the outlet 236 relative to the rotational position of the engine's rotor (as indicated by the cam 200) so that, for example, high pressure gas is provided to the engine the instant that one of the pivot arms 124a, 124b (FIGS. 1-3) moves past the gas inlet 134.

Although one gas injection mechanism is shown, it should be appreciated that some embodiments of the system may not employ the gas injection mechanism. Furthermore, other embodiment of the system may include more than one gas injection mechanism. For example, embodiments of the present system may be configured with one gas injection mechanism for each pivot arm of the engine. That is, an engine including two pivot arms (e.g., as illustrated in FIGS. 1-3) may include two gas injection mechanisms, and so on. In this way, an amount of metered high-pressure gas provided to each pivot arm may be continuous through approximately one hundred eighty degree rotation of the rotor during which the gas reservoirs of first and second gas injection mechanism are filled and exhausted in an alternating manner. In this manner, the engine may operate smoothly and continuously such that maximum utilization of high pressure gas is achieved for high efficiency. The gas injection mechanism shown in FIGS. 6 and 7 is only one type of gas injection mechanism, and it should be appreciated that the present system may alternatively employ various gas injection mechanisms known in the art. For example, embodiments of the present system may employ one or more controllable fluid injectors or valves (e.g., a solenoid valve or the like) for opening and closing the inlet 234 and outlet 236 of the reservoir 230. Indeed, some embodiments may include electronic controls (e.g., a microprocessor, microcontroller, or the like) for operating one or more controllable valves relative to an output signal from a rotational position sensor such as the previously-mentioned rotary encoder.

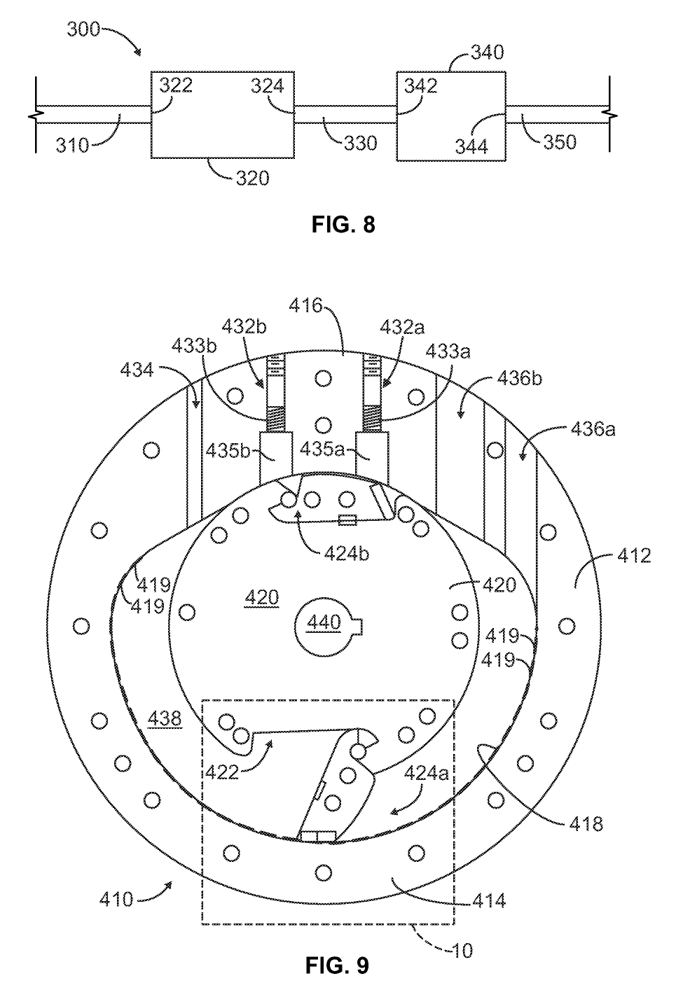

Referring now to FIG. 8, a pressure regulator for the system is described. The pressure regulator may be configured in various ways between the decomposition chamber 160 and the gas inlet 134 of the engine 110. In certain instances (e.g., a cold start) the pressure regulator may help the engine to achieve substantially immediate rotation regardless of the position of the rotor. As shown in FIG. 8, an example pressure regulator includes a first valve 320, which may be an electrically operated solenoid or mechanical valve, and a second valve 340, which may be a variable flow-control valve, that is in fluid communication with the first valve 320. A gas inlet pipe 310, which may be in fluid communication with the outlet 196 (FIG. 4) or pipe 250 (FIGS. 6-7), receives high pressure gas resulting from liquid H₂O₂ decomposition and provides the high pressure gas to an inlet 322 of the first valve 320. In operation (e.g., a cold start of the engine), the first valve 320 is opened to output high pressure gas to valve outlet 324 and an intermediate conduit or pipe 330 that is connected with an inlet 342 of second valve 340. The second valve 340, which may be of the variable flow type, opens or closes to adjust a gas pressure at the second valve's outlet 344 and the output conduit or pipe 350 connected thereto. Accordingly, high pressure gas being introduced to the gas inlet 134 of engine 110 may be adjusted (increasing or decreasing gas pressure) by valves 320, 340 relative to, for example a rotational position of the rotor. Additionally, the pressure regulator may be employed to choke-off or enrich the high pressure gas supply being provided to the engine while running to, for example, adjust the rotational speed of the engine.

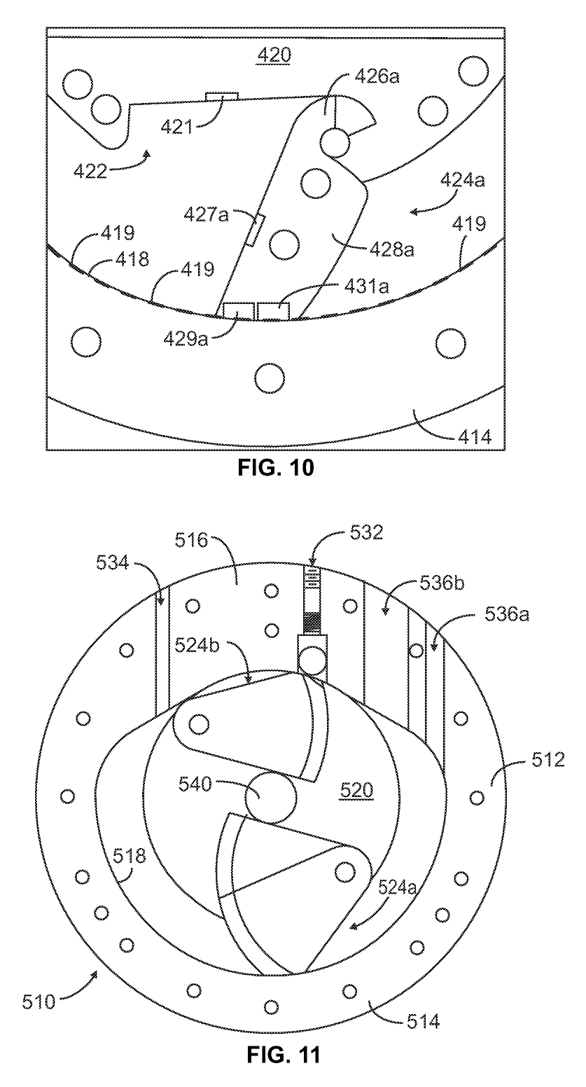

Turning now to FIGS. 9 and 10 another embodiment of the present engine is provided. As shown in FIG. 9, a second example engine 410, which is similar in some respect to engine 110 shown in FIGS. 1-3, includes a stator or housing 412 and a rotor 420 within the housing 412 that is configured to rotate relative to the housing 412. As shown, the housing 412 has a generally cylindrical configuration with a generally circular outer perimeter. An output shaft 440 of the rotor 420 is generally coaxial with a central axis extending through the housing 412 and, therefore the shaft 440 is centered with respect to the generally circular outer perimeter of the engine 410. The housing 412 includes two portions, namely a thin wall portion 414 and a thick wall portion 416 that are unitary or integral such that the housing 412 is one-piece. Due to the configuration of the thin wall and thick wall portions 414, 416, the inside wall or surface 418 of the housing 412 is generally lobed in shape. However, the housing 412 may be configured in other ways such that the inside wall or surface 418 is curvilinear or eccentric in shape relative to the configuration of the rotor 420. The rotor 420, which has a generally circular, cylindrical outer surface, is configured within the housing 412 with a portion of the outer surface of the rotor 420 being in contact with the inside wall or surface 418, particularly the inside surface of thick wall portion 416. As can be appreciated, the outer surface of the rotor 420 contacting with the inside wall or surface 418 provides a first seal to separate the expansion chamber 438 (i.e., the volume between the inside surface 418 of the housing 412 and the outer surface of the rotor 420) into two or more areas. As shown, sealing members 432a, 432b may be configured in the housing 412 (e.g., spaced apart as shown) to further separate the high pressure gas inlet 434 from the low pressure outlet 436. Since sealing members 432a, 432b are substantially similar, only sealing member 432a will be described hereafter for brevity. As shown, sealing member 432a includes a spring 433a configured in a blind hole of thick wall portion 416, and a seal 435a connected with the spring 433a. The spring 433a urges the seal 435a to continuously contact a surface of the rotor 420. The seal 435a may have a curved surface that is complementary to the surface of the rotor 420. Furthermore, the seal 435a may be made of various materials known in the art including metal, plastic, rubber, etc. In some embodiments, seals 435a, 434b are formed of a material having inherent lubricity.

As further shown in FIG. 9, the rotor 420 includes a central output shaft 440 for transferring rotational movement and energy to an external apparatus that is coupled with the shaft 440. The rotor 420 also includes two cavities or recesses 422a, 422b in the surface of the rotor 420 and two pivoting pressure seal arms 424a, 424b (hereinafter referred to as arms or PPSAs). Although two cavities or recesses 422a, 422b and two corresponding arms 424a, 424b are shown, it should be appreciated that the rotor 420 may be configured with additional (e.g., a plurality of) recesses or arms. As shown, the arms 424a, 424b are substantially similar to each other and are configured in a diametrically opposed orientation (i.e., oriented about one hundred eighty degrees from each other) such that when the rotor 420 is bisected by a plane extending through a center of the shaft 440 a first half of the rotor 420 including the first arm 424a is a mirror image of a second half of the rotor 420 including the second arm 424b. As can be appreciated, arms 424a, 424b are configured to be somewhat thicker than the arms 124a, 124b of FIGS. 1-3 for accommodating a magnetic biasing means which will be described hereinafter. Since the arms 424a, 424b are substantially similar, only arm 424a will be described hereinafter for brevity.

As shown in FIG. 10, arm 424a includes a first portion 426a and a second portion 428a. First portion 426a is pivotally or hingably coupled with the rotor 420 and second portion 428a extends outward from the first portion to terminate in a distal end containing magnets 429a and 431a. First portion 426a may be coupled with a pin or rod attached to the rotor 420. In some embodiments the pin or rod to which first portion 426a attaches may be made of a material that is resistant to the environment within the expansion chamber 438—a high moisture, high oxygen environment that may cause rapid corrosion/oxidation of some materials. To this end, the pin or rod may be formed of bronze, types of stainless steel, ceramics, etc. The distal end of second portion 428a is configured to contact the inner surface 418 of the housing 412, particularly the inner surface of thin wall portion 414, thereby dividing the expansion chamber 438 (FIG. 9) into two or more portions: a first portion that is between the distal end of portion 428a and the gas inlet 434 (FIG. 9); and a second portion that is between the distal end of second portion 428a and the distal end of second portion 428b of the diametrically opposed arm 424b. As further shown in FIG. 10, second portion 428a further includes magnet 427a in between its distal end and the first portion 426a. As can be appreciated, magnet 427a is configured to magnetically interact with corresponding magnet 421 on the rotor 420, particularly on the recess 422. Magnets 421 and 427a are configured or oriented to repel each other, thereby biasing the arm 424a outwardly such that the distal end of second portion 428b pivots away from the rotor 420. As further shown in FIGS. 9 and 10, the housing 412 further includes ferromagnetic metal members 419 (e.g., mu-metal, soft iron, etc.) which are recessed into the inner wall 418 of the housing 412. As shown in FIG. 9, the ferromagnetic metal members 419 are configured along the thin wall portion 414 of housing 412 between a first point proximate to the gas inlet 434 to a second point proximate to the gas outlet 436a. The ferromagnetic metal members 419 may be recessed into the housing 412 and covered by an electrically conductive metal (e.g., silver, copper, aluminum, etc.) that acts as an eddy current repelling mechanism for the magnets 429a, 431a on the distal end of second portion 428a of arm 424a (and magnets on the distal end of diametrically opposed arm 424b).

Accordingly, when the arm 424a is stationary (e.g., the rotor 420 not rotating), magnetic attraction between the ferromagnetic metal members 419 and magnets 429a, 431a causes the arm 424a to remain in a fully extended position, awaiting pressure to initiate movement. When the arm 424a is extended during rotation of rotor 420, the ferromagnetic metal members 419 and magnets 429a, 431a interact, thereby causing an effect known in the art as “eddy current repulsion” in which the magnets 429a, 431a are repelled slightly away from the inner surface 418. This slight repelling action reduces the physical contact and friction between the distal ends of the arms 424a, 424b and the inner surface 418, thereby allowing a thin layer of gasses (a type of fluid bearing) to form. During high rotational speed operation, the slight repelling action is substantially overcome by centrifugal force, causing the arms 424a, 424b to extend strongly towards the inner surface 418. In some embodiments, the combination of the foregoing attraction and repelling forces maximizes the seals between the distal ends of the arms 424a, 424b and the inner surface 418 to reduce the friction and noise produced by rotation of rotor 420.

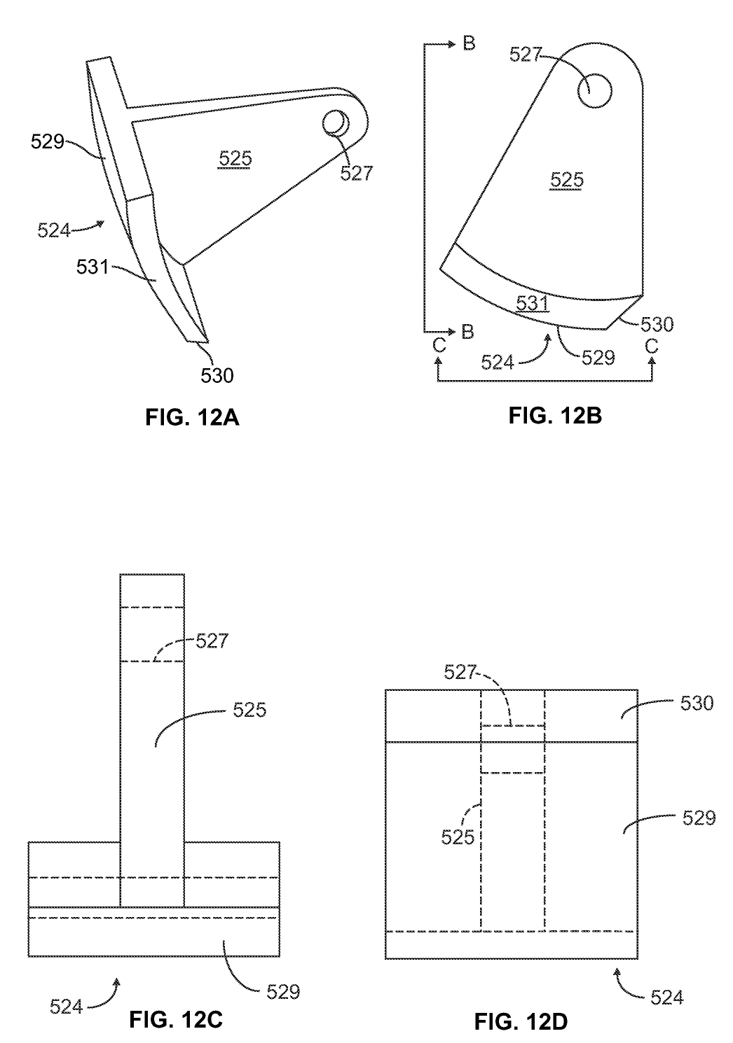

Turning now to FIGS. 11 and 12A-D, another embodiment of the present engine is provided. As shown in FIG. 11, the third example engine 510 is similar in some respects to previously-described engine 110 (FIGS. 1-3) and engine 410 (FIG. 9). As shown in FIG. 11, the engine 510 includes a stator or housing 512 and a rotor 520 within the housing 512 that is configured to rotate relative to the housing 512. As shown, the housing 512 has a generally cylindrical configuration with a generally circular outer perimeter. An output shaft 540 of the rotor 520 is generally coaxial with a central axis extending through the housing 512 and, therefore the shaft 540 is centered with respect to the generally circular outer perimeter of the engine 510. The housing 512 includes two portions, namely a thin wall portion 514 and a thick wall portion 516 that are unitary or integral. Accordingly, the inside wall or surface 518 of the housing 512 is generally lobed in shape. However, the housing 512 may be configured in other ways such that the inside wall or surface 518 is curvilinear or eccentric in shape relative to the configuration of the rotor 520. The rotor 520, which has a generally circular, cylindrical outer surface, is configured within the housing 512 with a portion of the outer surface of the rotor 520 being in contact with the inside wall or surface 518, particularly the inside surface of thick wall portion 516. As can be appreciated, the outer surface of the rotor 520 contacting with the inside wall or surface 518 provides a first seal to separate the expansion chamber (i.e., the volume between the inside surface 518 of the housing 512 and the outer surface of the rotor 520) into two or more areas. As shown, a sealing member 532 may be configured in the housing 512 to further separate the high pressure gas inlet 534 from the low pressure outlet 536. Sealing member 532 may be substantially similar to previously-described sealing members 432a, 432b (FIG. 9).

As further shown in FIG. 11, the rotor 520 includes a central output shaft 540 for transferring rotational movement and energy to an external apparatus that is coupled with the shaft 540. The rotor 520 also includes two cavities or recesses in the surface of the rotor 520 and two pivoting pressure seal arms 524a, 524b (hereinafter referred to as arms or PPSAs) that are complementary-shaped relative to the cavities. Although two cavities or recesses and two corresponding arms 524a, 524b are shown, it should be appreciated that the rotor 520 may be configured with additional (e.g., a plurality of) recesses or arms. As shown, the arms 524a, 524b are substantially similar to each other and are configured in a diametrically opposed orientation (i.e., oriented about one hundred eighty degrees from each other). As shown, the arms 524a, 524b are pivotally connected to a bar, rod or pin extending through the rotor 520 that is parallel to the output shaft 540. Arms 524a, 524b are configured to be somewhat more robust than the previously-described arms 124a, 124b of FIGS. 1-3 and arms 424a, 424b of FIG. 9.

Referring to FIG. 12A, the arm 524 is shown in a perspective view. FIG. 12B is a plan view of the arm 524 shown in FIG. 12A. FIG. 12C is an elevation view of the arm 524 according to view B-B shown in FIG. 12B, and FIG. 12D is an elevation view of the arm 524 according to view C-C shown in FIG. 12B. As shown, arm 524 includes a planar, generally triangular-shaped body portion 525, and a seal portion 529 that extends generally perpendicularly from the body portion 525. The body portion 525 includes an aperture 527 proximate to a vertex of the body portion 525 through which a pin, rod or bar of the rotor 520 extends to pivotally couple the arm 524 to the rotor 520. As best shown in FIG. 12B, the seal portion 529 of the arm 524 is generally arcuate in shape and includes a sealing surface 530. As shown in FIG. 11, the sealing surface 530 is configured to abut or contact the inner surface 518. As further shown in FIG. 12B, the seal portion 529 includes an edge surface 531 that is generally parallel to and spaced away from the body portion 525. As shown in FIG. 12C, the arm 524 has another edge surface that is parallel with the edge surface 531 shown in FIG. 12B such that the arm 524 has a generally T-shaped configuration when viewed end-on. However, it should be appreciated that the pivoting pressure seal arms of the present system and engine may be formed in various configurations.

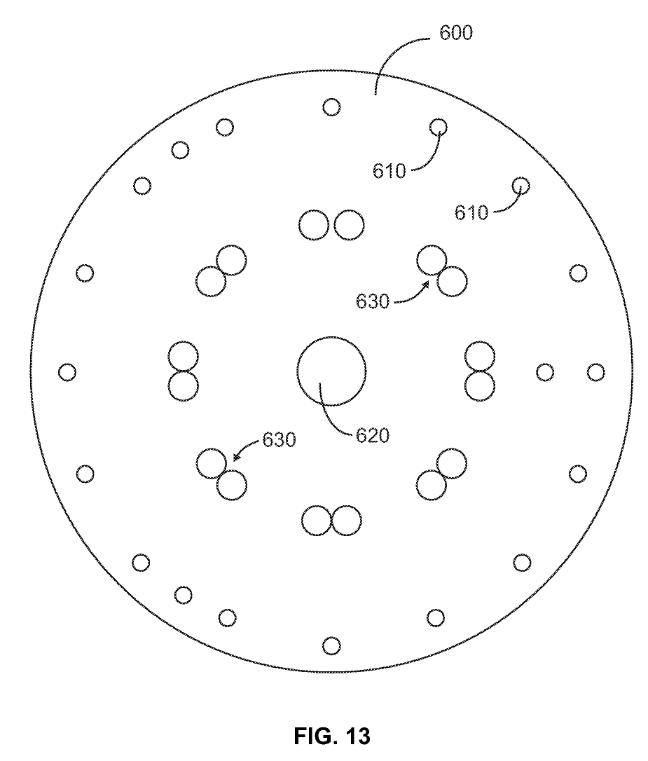

Turning now to FIG. 13, an end plate for an embodiment of the present engine is described. In embodiments of the present engine that employ magnetic biasing means (e.g., engine 410 of FIG. 9), such engines may further include an end plate that facilitates generation of electricity. As shown in FIG. 13, the end plate 600 may be connected to an end of the engine by inserting fasteners (e.g., bolts, screws, pins, etc.) through the apertures 610 which are configured to align with corresponding apertures in the housing (see FIG. 9 showing apertures in the housing 412). The end plate 600 further includes a central aperture 620 for extending the output shaft of the engine's rotor therethrough for connection with another shaft or object. Embedded in the end plate 600 are generator coils 630 that produce electricity (i.e., current and voltage) relative to rotation of the rotor, more particularly movement of the magnets configured thereon (e.g., magnet 421 shown in FIG. 10, etc.) As the magnets on the rotor travel past the coils 630, the coils 630 experience an electromagnetic field (EMF) effect, thereby generating a given amount of electricity according to Faraday's law of induction. Electricity generated by the coils 630 may then be transferred to power various loads. This electricity-generation capability may be advantageous in certain contexts or applications, for example, using the present rotary expansion engine to provide motive power to a vehicle. In this application, the present rotary expansion engine may also obviate the need for conventional batteries, alternators, generators, etc. which are typically used to power electrical accessories (e.g., lights, radio, etc.) in the vehicle.

In view of the foregoing it can be appreciated that the present rotary expansion engine has a small number of moving and stationary parts when compared with other engines known in the art (e.g., combustion-type engines). Furthermore, the present rotary expansion engine may have a compact (e.g., about seventy five cubic inch volume) and light (e.g., about twenty kg) configuration. Embodiments of the present rotary expansion engine may be constructed of suitable materials such as aluminum and have few discreet parts. Interior and/or friction surfaces of the present engine may be class-three anodized, creating an extremely smooth and durable two mil coating (e.g. of aluminum oxide) on various surfaces. This construction provides a durable and light engine.

One embodiment of the present engine was found to deliver torque and motive power at a level disproportionate to the engine's size and weight and far greater than a comparably-sized internal combustion engine. In fact, the embodiment of the engine that was tested was found to have unique torque characteristics at low speed (RPM). The test procedure is now described.

The engine was first secured to a test table and then the output shaft of the engine was connected to a hydraulic dynamometer via a universal linkage. The engine was then connected to a compressed gas source with a variable pressure outlet to simulate the dynamic operation of a hydrogen peroxide fueled reaction chamber. Testing was conducted in ten psi increments, starting at ten psi. The dynamometer was a standard hydraulic-resistance type in which fluid is pumped (using the power of the engine being tested) through a closed cycle. A valve in this loop may be closed to increase the load/resistance (torque) that the engine is experiencing. By recording this torque and the rpm that the engine is producing at a given time, the horsepower was calculated.

Initially, a performance base line was established by running the engine without an artificial load to determine free rpm derived directly from pressure. Next, the engine was provided with a constant pressure of ten psi. The dynamometer valve was then gradually closed to reduce the rpm of the engine to a given level, and the amount of resistance (torque) needed to slow the engine to that level rpm was recorded. The pressure was then increased in ten psi increments and finally, the engine was provided with a constant pressure of fifty psi and tested in the same manner as before.

At the fifty psi point the engine demonstrated a unique torque characteristic. That is, the engine was found to produce torque similar to an electric motor, which has max torque at near-zero speed. As the dynamometer load was increased the torque increased and the engine slowed. However, the engine was still producing so much torque at such incredibly low rpm that the hydraulic dynamometer had reached its limit of being able to calculate resistance due to the low rpm produced by the engine. That is, the engine was producing too much torque at too low an rpm to continue accurate measurement at different (e.g., higher) psi levels. Indeed, the engine continued to run at less than one hundred rpm and still produced significant amounts of torque.

In view of the foregoing the present engine is closer in characteristics to an electric motor than a conventional IC engine. To this end, the present engine may be used in vehicle application to provide motive power directly to the vehicle's drive wheels and without the need for the torque-multiplying assistance of a transmission.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Various embodiments of this invention are described herein. However, it should be understood that the illustrated and described embodiments are exemplary only, and should not be taken as limiting the scope of the invention.

What is claimed is:

1. A hydrogen peroxide-fueled engine system comprising:
a source outputting liquid hydrogen peroxide;
a decomposition chamber including an inlet in fluid communication with the source for receiving the liquid hydrogen peroxide, an outlet, and a catalyst interposed between the inlet and the outlet; and
a rotary expansion engine including a gas outlet, a gas inlet in fluid communication with the outlet of the decomposition chamber, a generally lobe-shaped expansion chamber in fluid communication with the gas inlet and the gas outlet, and a rotor contacting a surface of the lobe-shaped expansion chamber between the gas outlet and the gas inlet, the rotor including an output shaft and diametrically-opposed first and second sealing arms that pivot outwardly to contact the surface.

2. The system of claim 1 wherein the decomposition chamber comprises:
a catalyst bed holding the catalyst in a high surface area configuration;
a pipe between the source and the catalyst bed;
a pressure vessel enclosing the catalyst bed and a portion of the pipe, the pressure vessel including a high pressure gas outlet in fluid communication with the gas inlet of the rotary expansion engine; and
thermal insulation surrounding the pressure vessel.

3. The system of claim 2 wherein the pipe including a helical portion extending around the catalyst bed for pre-heating liquid hydrogen peroxide entering the catalyst bed.

4. The system of claim 2 further comprising a nozzle connected to an end of the pipe proximate to the catalyst bed, the nozzle injecting atomized liquid hydrogen peroxide into the catalyst bed for reaction with the catalyst.

5. The system of claim 2 further comprising a pump between the reservoir and the catalyst bed for pressurizing the liquid hydrogen peroxide.

6. The system of claim 1 further comprising:
a gas reservoir in fluid communication with the outlet of the decomposition chamber for containing high pressure, high temperature gas resulting from reaction of the liquid hydrogen peroxide with the catalyst; and
an injection mechanism in fluid communication with the gas reservoir and the gas inlet of the rotary expansion engine for selectively injecting high pressure, high temperature gas into the expansion chamber relative to a rotational position of the rotor.

7. The system of claim 6 wherein the injection mechanism comprises:
a controllable valve for selectively sealing one of an inlet and an outlet of the gas reservoir; and
a timing mechanism for coordinating operation of the controllable valve relative to a rotational position of the rotor.

8. The system of claim 7 wherein the timing mechanism comprises:
a cam rotatably coupled with the output shaft of the rotor; and
a linkage including a first end connected with an armature of the controllable valve, and a second end having a cam follower contacting a perimeter of the cam, the linkage converting rotational movement of the output shaft to linear reciprocating movement of the armature.

9. The system of claim 7 wherein the timing mechanism comprises a rotary encoder coupled with the output shaft of the rotor for outputting a signal indicative of a rotational position of the rotor, and
wherein the controllable valve is a solenoid valve operable relative to the signal.

10. The system of claim 6 further comprising a pressure regulator in fluid communication with the gas reservoir and the injection mechanism, the pressure regulator comprising:
a two-way valve in fluid communication with high pressure, high temperature gas from the gas reservoir; and
a flow-control valve downstream of the two-way valve for controlling output of the high pressure, high temperature gas to the gas inlet of the rotary expansion engine.

11. The system of claim 1 wherein each of the first and second sealing arms comprises:
a first portion pivotally coupled with the rotor;
a second portion including a first end coupled with the first portion and a second end distal from the first portion; and
a normal bias urging the second end against the surface.

12. The system of claim 11 wherein the normal bias comprises:
a first magnet on a portion of the rotor configured to receive the sealing arm; and
a second magnet on a portion of the sealing arm that contacts the portion of the rotor when the sealing arm is in a retracted state, the first and second magnets being oriented to repel each other.

13. The system of claim 12 wherein the rotary expansion engine further comprises an end plate including coils embedded therein, the coils generating electricity relative to rotation of the first and second magnets.

14. The system of claim 11 wherein the normal bias comprises:
a first magnet on the second end; and
second magnets embedded in a portion of the surface, the second magnets being oriented to repel the first magnet.

15. The system of claim 1 further comprising an exhaust pipe extending around the rotary expansion engine for transferring heat energy of exhaust gasses to the expansion chamber.

16. A method of producing rotational energy from liquid hydrogen peroxide, the method comprising:
configuring a rotary expansion engine with a gas outlet, a gas inlet, a generally lobe-shaped expansion chamber in fluid communication with the gas inlet and the gas outlet, and a rotor contacting a surface of the lobe-shaped expansion chamber between the gas outlet and the gas inlet, the rotor including an output shaft and diametrically-opposed first and second sealing arms that pivot outwardly to contact the surface;
configuring a decomposition chamber between a source of liquid hydrogen peroxide and the rotary expansion engine, the decomposition chamber including an inlet in fluid communication with the source for receiving the liquid hydrogen peroxide, an outlet for outputting high pressure gas to the gas inlet of the rotary expansion engine, and a catalyst interposed between the inlet and the outlet; and
injecting the liquid hydrogen peroxide into the decomposition chamber for reacting with the catalyst, the liquid hydrogen peroxide decomposing to a high pressure gas for turning the rotor.

17. The method of claim 16 further comprising heating the liquid hydrogen peroxide.

18. The method of claim 16 wherein the injecting step further comprises atomizing the liquid hydrogen peroxide.

19. The method of claim 16 further comprising the step of regulating at least one of a pressure and a volume of the high pressure gas.

20. The method of claim 16 wherein the injecting step further comprises:
determining a rotational position of the rotor; and
operating a gas injection mechanism relative to the rotational position determined from the determining step for timing introduction of the high pressure gas into the gas inlet.
